(19) United States
(12) Patent Application Publication
(10) Pub. No.: US 2015/0231498 A1
(43) Pub. Date: Aug. 20, 2015

(54) UNIVERSAL CONTROLLER INTERPRETER

(71) Applicant: DINGMEDIA, LTD., FELTHAM (GB)

(72) Inventors: Robert Hain, Limassol (CY); Svetlana Astakhova, Limassol (CY); Maxim Gutchenko, Limassol (CY)

(73) Assignee: DINGMEDIA, LTD., FELTHAM (GB)

(21) Appl. No.: 14/624,134

(22) Filed: Feb. 17, 2015

Related U.S. Application Data
(63) Continuation-in-part of application No. 14/199,945, filed on Mar. 6, 2014.
(60) Provisional application No. 61/940,818, filed on Feb. 17, 2014.
(60) Provisional application No. 61/940,814, filed on Feb. 17, 2014.

(51) Int. Cl. A63F 13/40; A63F 13/23; A63F 13/22; G06F 3/038; G06F 3/033

(52) U.S. Cl. CPC A63F 13/40; G06F 3/038; G06F 3/033; A63F 13/22; A63F 13/23; G06F 2203/0382; G06F 2203/0383; G06F 2203/0384

(57) ABSTRACT

Embodiments of the present invention are generally directed towards utilization of various controllers in a cross-platform manner. Specifically, embodiments of the present invention are configured to provide a multiplatform controller that allows for the playing of video games through a computer console with the ability to use controllers (Gamepad type) of different brands and models.

### FIELD OF THE INVENTION

Embodiments of the present invention are generally directed towards utilization of various third-party controllers on a cross-platform manner. Specifically, embodiments of the present invention provide a system for using third-party controllers, for the playing of video games on a computer console, where the computer console is not the console originally intended for use with the third-party controller. Preferred embodiments of the present invention are contemplated for use with a universal controller interpreter that interprets third-party controller commands into events usable by a gaming system of the present invention.

### CROSS REFERENCE TO RELATED APPLICATIONS

This application claims the benefit of U.S. Provisional Patent Application No. 61/940,814, filed Feb. 17, 2014, the entire disclosure of which is incorporated herein by reference. This application also claims benefit of U.S. patent application Ser. No. 14/199,945, filed Mar. 6, 2014, which claims the benefit of U.S. Provisional Patent Application No. 61/940,818, filed Feb. 17, 2014, the entire disclosures of which are incorporated herein by reference.

### BACKGROUND

Current consoles including X-Box, PlayStation and NVidia's Shield come with Native controllers that are not interchangeable. A user who is used to playing games on one controller frequently has difficulties adapting to a new controller on a different gaming platform. This can lead to both the gamer being platform dependent (i.e., only playing games available on the console they are most comfortable with) and unable to compete with other players on separate systems.

Another disadvantage of tying controllers to specific systems is that it eliminates or restricts the ability for third party controller manufacturers to provide optimized cross-platform controllers. Further, third party controller manufacturers are required to make a separate controller for each platform, which required additional resources and capital to modify each design for each platform.

By default, other TV Boxes or game consoles don't support non-native game controllers.

Game controller users spend thousands of hours perfecting their game play on their own controllers and find it very hard to move to other controllers as consoles are upgraded/change. Controllers are sophisticated and have many buttons location in different places on different controllers. Much like musical instruments, controller adaption takes a long time and this skill is lost when the user switches to a new controller.

Therefore, there is need in the art for systems and methods for using third-party controllers, for the playing of video games on a computer console, where the computer console is not the console originally intended for use with the third-party controller. These and other features and advantages of the present invention will be explained and will become obvious to one skilled in the art through the summary of the invention that follows.

### SUMMARY OF THE INVENTION

Accordingly, it is an aspect of the present invention to provide system and methods for using third-party controllers, for the playing of video games on a computer console, where the computer console is not the console originally intended for use with the third-party controller.

According to an embodiment of the present invention, a system for providing a universal controller interpreter comprises: a universal controller interpretation module, comprising computer-executable code stored in non-volatile memory, and a processor, one or more input means, wherein at least one of the input means is a controller device, wherein the universal controller interpretation module, the processor and the one or more input means are operably connected and are configured to: receive event data and controller identification data; process controller identification data in order to identify the input means; process event data into one or more input events; interpret each of the one or more input events into game events usable by a running game; and implement the game events for the running game.

According to an embodiment of the present invention, the universal controller interpretation module, the processor and the one or more input means are further configured to retrieve controller identification information from a remote computing system.

According to an embodiment of the present invention, the universal controller interpretation module, the processor and the one or more input means are further configured to retrieve controller event information from the remote computing system, wherein the controller event information is associated with the controller identification information and enables the universal controller interpretation module to process event data from the input means.

According to an embodiment of the present invention, the universal controller interpretation module, the processor and the one or more input means are further configured to enter into a controller training process when the controller identification data is unknown to the universal controller interpretation module.

According to an embodiment of the present invention, the universal controller interpretation module, the processor and the one or more input means are further configured to receive event data training information from the input means.

According to an embodiment of the present invention, the universal controller interpretation module, the processor and the one or more input means are further configured to process event data training information into useable event data.

According to an embodiment of the present invention, the universal controller interpretation module, the processor and the one or more input means are further configured to generate controller identification information for an unknown controller type from the useable event data.

According to an embodiment of the present invention, the universal controller interpretation module, the processor and the one or more input means are further configured to store the controller identification information for later use with the input means.

According to an embodiment of the present invention, a method for providing a universal controller interpreter comprises the steps of: receiving at a universal controller interpretation module, event data and controller identification data from an input means; processing controller identification data in order to identify the input means; processing event data into one or more input events; interpreting each of the one or more input events into game events usable by a running game; and implementing the game events for the running game.

According to an embodiment of the present invention, the method further comprises the step of retrieving controller identification information from a remote computing system.

According to an embodiment of the present invention, the method further comprises the step of retrieving controller event information from the remote computing system, wherein the controller event information is associated with the controller identification information and enables the universal controller interpretation module to process event data from the input means.

According to an embodiment of the present invention, the method further comprises the step of entering into a controller training process when the controller identification data is unknown to the universal controller interpretation module.

According to an embodiment of the present invention, the method further comprises the step of receiving event data training information from the input means.

According to an embodiment of the present invention, the method further comprises the step of processing event data training information into useable event data.

According to an embodiment of the present invention, the method further comprises the step of generating controller identification information for an unknown controller type from the useable event data.

According to an embodiment of the present invention, the method further comprises the step of storing the controller identification information for later use with the input means.

### BRIEF DESCRIPTION OF THE DRAWINGS

FIG. 1 illustrates a schematic overview of a computing device, in accordance with an embodiment of the present invention;

FIG. 2 illustrates a network schematic of a system, in accordance with an embodiment of the present invention;

FIG. 3A illustrates a schematic of a system for providing a universal controller interpreter, in accordance with an embodiment of the present invention;

FIG. 3B illustrates a schematic of a system for providing a universal controller interpreter, in accordance with an embodiment of the present invention;

FIG. 3C illustrates a schematic of a system for providing a universal controller interpreter, in accordance with an embodiment of the present invention;

FIG. 4 is an illustration of an exemplary embodiment of a controller that can be used in conjunction with a system for providing a universal controller interpreter, in accordance with an embodiment of the present invention;

FIG. 5 is a process flow of an exemplary method in accordance with embodiments of the present invention;

FIG. 6 is a process flow of an exemplary method in accordance with embodiments of the present invention;

FIG. 7 illustrates an exemplary depiction of an overlay model in accordance with embodiments of the present invention;

FIG. 8A is a an illustration of an exemplary embodiment of a controller that may be utilized in conjunction with the system in order to record controller events, in accordance with embodiments of the present invention;

FIG. 8B is a an illustration of an exemplary embodiment of a controller that may be utilized in conjunction with the system in order to record controller events, in accordance with embodiments of the present invention;

FIG. 8C is a an illustration of an exemplary embodiment of a controller that may be utilized in conjunction with the system in order to record controller events, in accordance with embodiments of the present invention;

FIG. 8D is a an illustration of an exemplary embodiment of a controller that may be utilized in conjunction with the system in order to record controller events, in accordance with embodiments of the present invention;

FIG. 8E is a an illustration of an exemplary embodiment of a controller that may be utilized in conjunction with the system in order to record controller events, in accordance with embodiments of the present invention;

FIG. 8F is a an illustration of an exemplary embodiment of a controller that may be utilized in conjunction with the system in order to record controller events, in accordance with embodiments of the present invention;

FIG. 8G is a an illustration of an exemplary embodiment of a controller that may be utilized in conjunction with the system in order to record controller events, in accordance with embodiments of the present invention;

FIG. 8H is an illustration of an exemplary embodiment of a controller that may be utilized in conjunction with the system in order to record controller events, in accordance with embodiments of the present invention;

FIG. 8I is an illustration of an exemplary embodiment of a controller that may be utilized in conjunction with the system in order to record controller events, in accordance with embodiments of the present invention;

FIG. 8J is an illustration of an exemplary embodiment of a controller that may be utilized in conjunction with the system in order to record controller events, in accordance with embodiments of the present invention; and

FIG. 9 is an illustration of a timeline showing controller events occurring and being recorded by the system, in accordance with embodiments of the present invention.

### DETAILED SPECIFICATION

Embodiments of the present invention allow for players of various console systems and other gaming systems (e.g., PC gaming) to use their own controller without the need to purchase an additional controller or having to utilize the sole controller that comes with a console. Advantageously, this results in a substantial savings to the customer and reduces production costs. Further embodiments of the present invention allow the user to use a single game controller for both an originally intended platform (e.g., PC, Mac. Xbox, Xbox One, PlayStation 3, PlayStation 4, Wii, WiiU, Steam Box, other third party proprietary systems) and a gaming system of the present invention. Embodiments of the present invention obviate the need for users to change controllers when switching between an originally intended console and the system of the present invention.

According to an embodiment of the present invention, the system and methods described herein provide support of non-native game controllers, comprising: technology of Plug & Play for most popular game controllers, hint support for the choice of each button during a game or while controlling the console, and the ability to connect several game controllers at the same time and control the console or play hotseat/multiplayer for two joy stick games. Embodiments of the present invention also provide for the ability to add several game controllers to a console system that may not otherwise support multiple controllers (e.g., Android) which allows developers to develop hotseat games for consoles that would not otherwise support these game types.

According to an embodiment of the present invention, the system and methods described herein provide users the ability to use their own controller from a third-party gaming system on a gaming system of the present invention. In a preferred embodiment of the present invention, the multiplatform controlled described herein is in the form of a standard two hand controller, comprising one or more buttons, one or more directional pads, one or more analog sticks, one or more triggers, or any combination thereof. In other embodiments, the multiplatform controller may comprise other controller types, including, but not limited to: wheels, guns, dance pads, motion bars/sensors, or any combination thereof. One of ordinary skill in the art would appreciate that there are numerous controller types that could be utilized with embodiments of the present invention, and embodiments of the present invention are contemplated for use with any controller type.

According to an embodiment of the present invention, the system and methods described herein may provide a software based interface, such as a software development kit (SDK) and/or other guideline for game developers to help them develop their games to fully support all the functionality of the multiplatform controller. For example there are no hot seat games on the Android market now, but with this solution game developers will be able to create them.

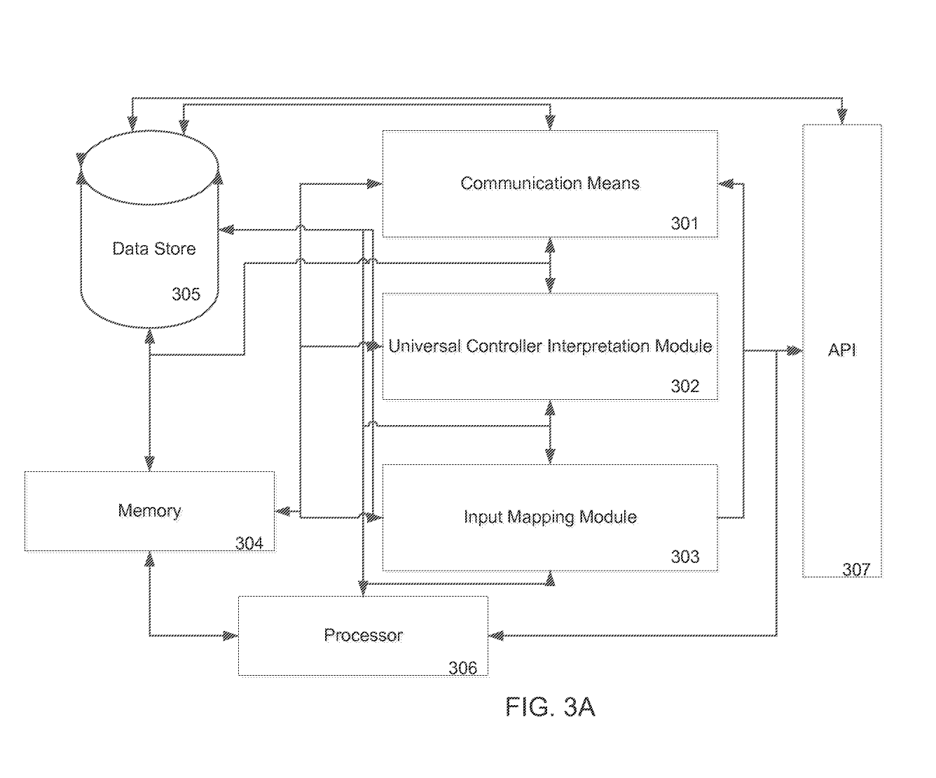

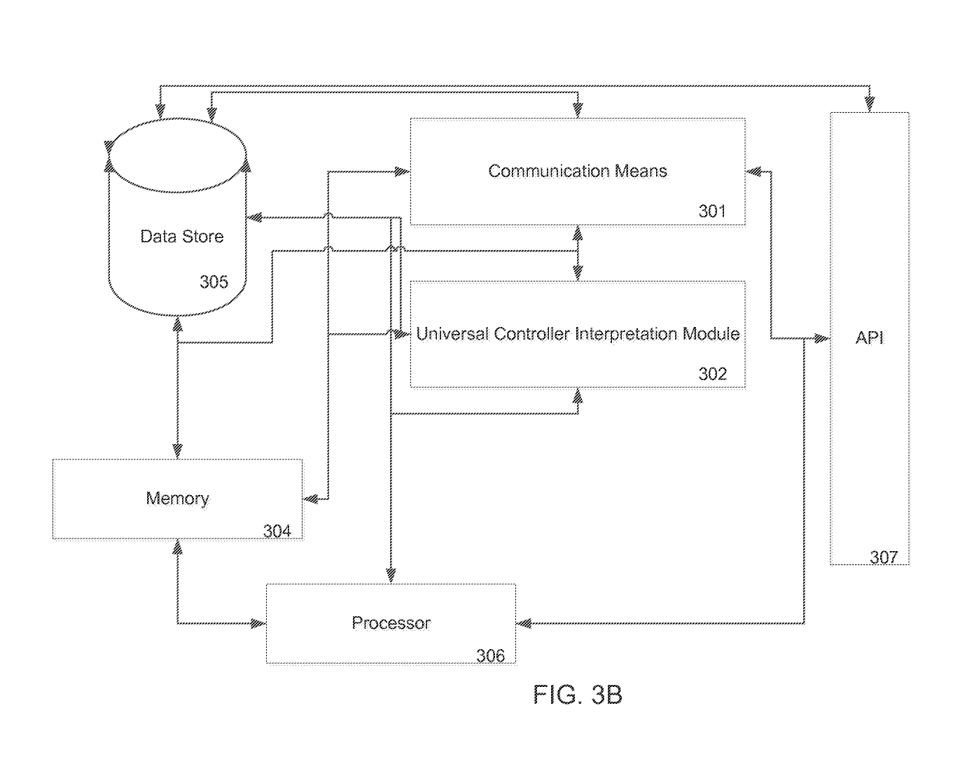

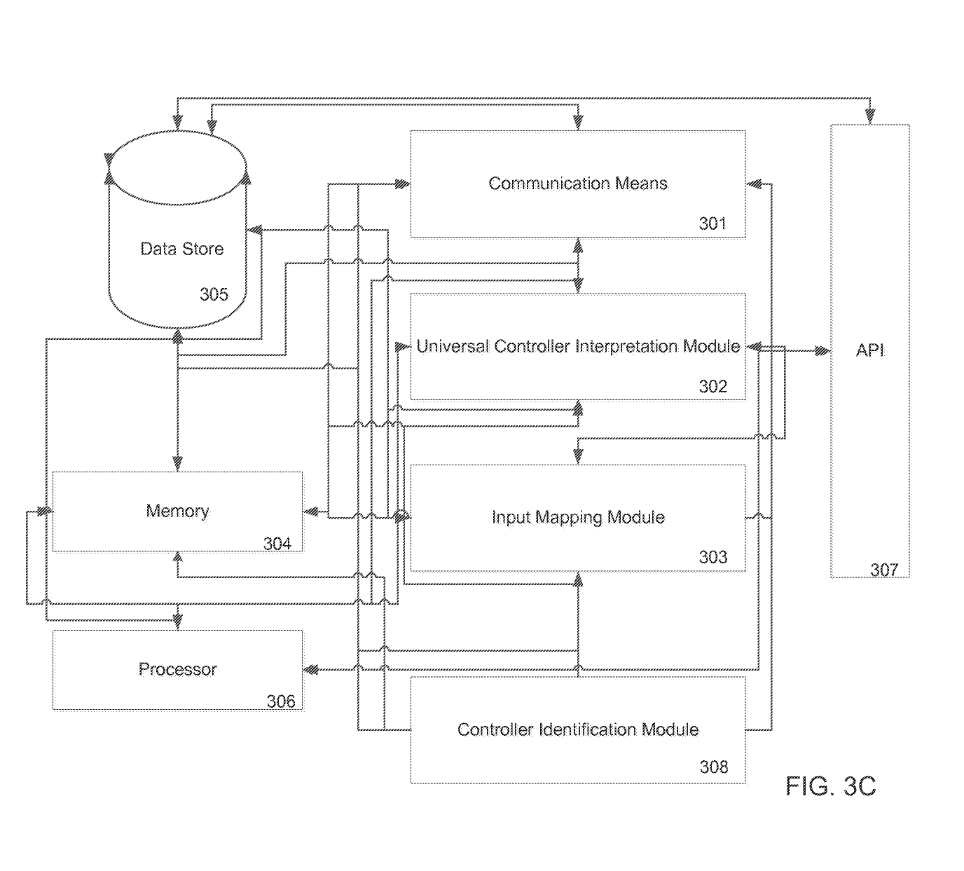

Turning to FIG. 3A, according to an embodiment of the present invention, a system for a universal controller interpreter is comprised of one or more communications means 301, a universal controller interpretation module 302, an input mapping module 303, memory 404, one or more data stores 305, a processor 306 and, optionally, a connected application programming interface (API) 307.

Turning to FIG. 3B, another embodiment of the present invention is shown, wherein a system for a universal controller interpreter is comprised of one or more communications means 301, a universal controller interpretation module 302, memory 404, one or more data stores 305, a processor 306 and, optionally, a connected application programming interface (API) 307.

Turning to FIG. 3C, according to an embodiment of the present invention, a system for a universal controller interpreter is comprised of one or more communications means 301, a universal controller interpretation module 302, an input mapping module 303, memory 404, one or more data stores 305, a processor 306, an optional connected application programming interface (API) 307, and a controller identification module 308. In alternate embodiments, the system may have additional or fewer components. One of ordinary skill in the art would appreciate that the system may be operable with a number of optional components, and embodiments of the present invention are contemplated for use with any such optional component.

According to an embodiment of the present invention, the communications means of the system may be, for instance, any means for communicating data over one or more networks or to one or more peripheral devices for communication with the system. Appropriate communications means may include, but are not limited to, wireless connections, wired connections, cellular connections, data port connections, Bluetooth connections, or any combination thereof. One of ordinary skill in the art would appreciate that there are numerous communications means that may be utilized with embodiments of the present invention, and embodiments of the present invention are contemplated for use with any communications means.

In a preferred embodiment of the present invention, the universal controller interpretation module 302 is configured to receive event data and controller identification data from one or more controllers in order to identify the type of controller(s) that are interacting with the system and interpret each event received from the one or more controllers. Controller identification data may include, but is not limited to, manufacturer information, controller model information, connection type information (e.g., USB, Serial, Bluetooth, WIFI, Infrared (IR)), or any combination thereof. One of ordinary skill in the art would appreciate that there are numerous types of controller identification data that could be utilized with embodiments of the present invention, and embodiments of the present invention are contemplated for use with any type of controller identification data. Further, in certain embodiments, the functionality of the universal controller interpretation module 302 can be broken out into and provided by more than one module, such as having an embodiment where a controller identification module 308 is utilized to identify controller types interacting with the system, while the universal controller interpretation module 302 focuses on interpreting data events received from such controllers. One of ordinary skill in the art would appreciate that the functionality of the various modules can be combined or separated as required by various implementations, and any such division or combination of modules is contemplated for use with embodiments of the present invention.

Event data refers to information sent from a controller and received by the universal controller interpretation module associated with one or more events occurring on a controller. Events include, but are not limited to, button press, button release, analog stick movement, directional pad movement, directional pad press, directional pad release, trigger press, trigger release, mouse button press, mouse button release, key press, key hold, key release, or any combination thereof. One of ordinary skill in the art would appreciate that there are numerous types of events that could be sent as event data to the universal controller interpretation module, and embodiments of the present invention are contemplated for use with any type of event and event data.

According to an embodiment of the present invention, the universal controller interpretation module may work in conjunction with one or more processing (e.g., CPU) and data storage and retrieval modules (e.g., storage mediums, databases) in order to retrieve and process controller identification data in order to identify a controller type attempting to be utilized with a gaming system. In certain embodiments, if the universal controller interpretation module is unable to identify a controller type with information available to it from such storage and retrieval modules, the universal controller interpretation module can attempt to retrieve controller type information from a remote system (e.g., remote controller information server).

Further embodiments of the present invention may allow a universal controller interpretation module to identify and learn events and event data types from an otherwise unknown controller type by walking a user of the controller through a series of steps intended to identify event types in order to associate events with actions taken in association with a game. For instance, the universal controller interpretation module may notify the user, for example, via an attached display element (e.g., TV, monitor), to initiate an event data type (e.g., press button “X”, hold button “X”, release button “X”, analog stick down, analog stick up) and subsequently record the event data received from the unknown controller type. By associating the event data received with the appropriate control, even unknown controller types can be utilized with a gaming system. Further, in certain embodiments of the present invention, the universal controller interpretation module may store the event data and controller identification data of the unknown controller type for use later when a similar unknown controller is connected to the system. Still further, the system may be configured to share the stored information with one or more remote systems in order to provide unknown controller type information to other users who attempt to retrieve information about unknown controllers from such remote servers.

According to an embodiment of the present invention, the system may be configured to allow the use of third-party controllers and other physical controllers from otherwise non-compatible platforms. (e.g., Ouya, NVidia Shield. Mojo). These non-compatible platforms have specific controllers for use with their otherwise open source and compatible gaming systems. These gaming systems can be modified through use of embodiments of the present invention to utilize other third-party controllers. In still further embodiments, these platform specific controllers may also be utilized with a gaming system incorporating an embodiment of the present invention.

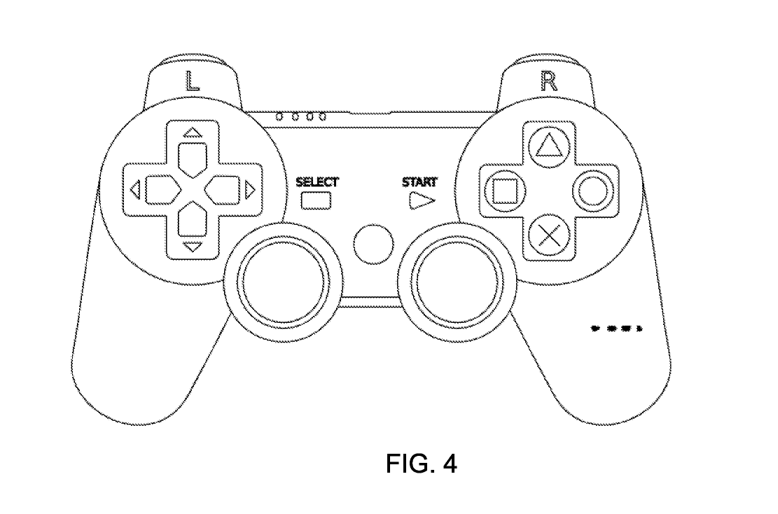

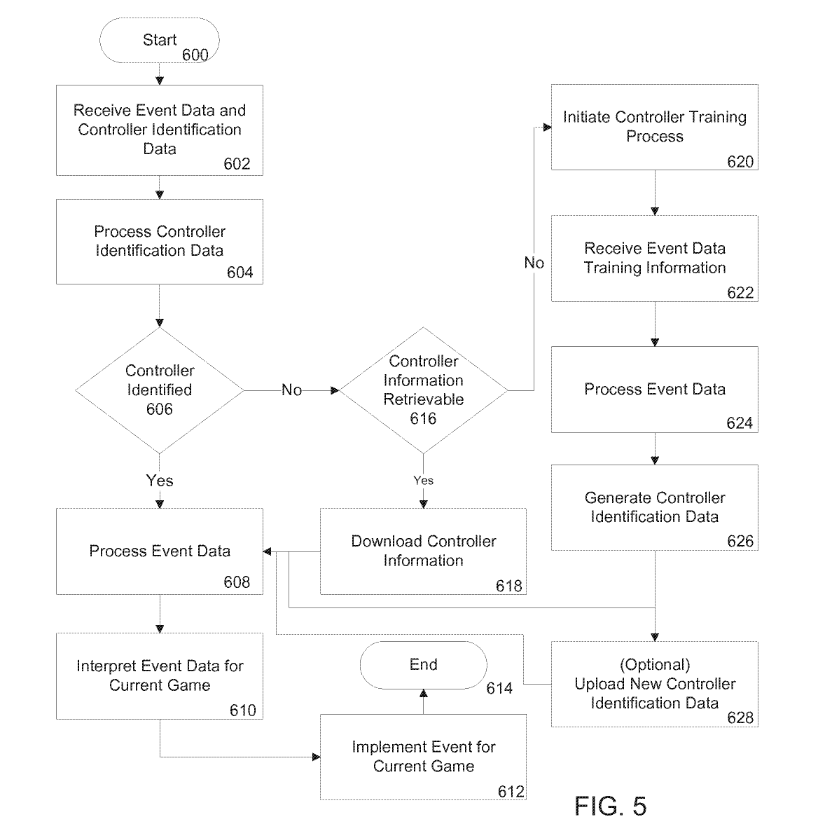

Turning now to FIG. 5, an exemplary method in accordance with an embodiment of the present invention is described. The process starts at step 600 with the system beginning the universal controller interpretation of inputs from a input device (e.g., controller). At step 602, the system receives event data and controller identification data from the input device for processing. Controller identification data comprises data required to identify a controller type (e.g., PlayStation 3 controller, PlayStation 4 controller, Xbox Controller) and can generally include information about the functionality of that controller type (e.g., motion data, force feedback, number and type of analog sticks, number and type of buttons). Event data received is related to the usage of the input means with the system, generally related to data being received by the input means in response to use by a user during gameplay.

At step 604, the system processes the controller identification data in order to ensure that the system is capable of understanding and utilizing the event data provided in conjunction with that input means type. At step 606, the system checks to see if it has information related to that controller type (e.g., type of input means).

Assuming the system is capable of identifying the input means, the system proceeds to step 608 and uses information stored or otherwise available to the system to process event data based on the identified controller type. By mapping the event data in relation to the controller type, the system is capable of understanding what events were intended by the user with respect to ongoing gameplay.

At step 610, the system interprets the processed event data into data usable by the running game. The interpretation process is generally a running process that is running concurrently with the running game so that the user can continually provide input and the system can provide the appropriate events to the running game (step 612). This process will continue until interrupted or otherwise terminated by the user or the system at step 614.

If the controller was not identified at step 606, the system may determine if it can retrieve information about the controller type at step 616. Generally, this can be done by contacting a remote system (e.g., server associated with the universal controller interpreter provider) and providing the controller identification data for identification by the remote system. If the remote system can identify the controller type, the system will retrieve that controller information (step 618) and continue the interpretation process at step 608.

In situations where the remote system is incapable of identifying the controller type, the system may enter into a controller training process (step 620). The training process generally starts with the system receiving event data training information from the input means (step 622) and allowing the user to map that event data manually to various event data for the current game (e.g., mapping a controller function to a key press or other event available in the running game). At step 624, the system processes the event data in association with the training information.

After the training process is complete, the system generates a new controller identification data for the trained input means (step 626). This way, whenever the controller identification data is received again, the system will be able to identify the input means without going through the training process again.

Optionally, at step 628, the system can be configured to upload or otherwise provide the newly generated controller identification data to a remote system for use by others that encounter the same type of input means.

Either way, once complete, the process returns to step 608 for the processing of event data with respect to the running game.

In certain embodiments of the present invention, the system may be configured to generate content overlays during the receipt and processing of controller event data. These content overlays are graphical or other displayable representations of the controller that may be provided in conjunction with video content of the associated gameplay. Such overlays may be provided during live broadcast of the video, such as live streaming of video games, or in a recording that can be consumed by users at a later time. The process of capturing and providing controller event data is described further in detail below.

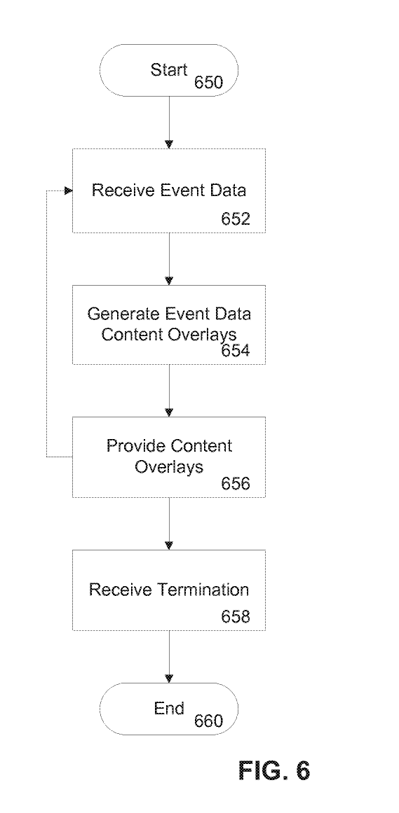

Turning now to FIG. 6, an exemplary method for providing event data received from input means in the form of content overlays for provision with other video content. The process starts at FIG. 650 with the overlay generation method running concurrently with the receipt and processing of event data from the controller as described herein. At step 652, the system receives event data for processing into content for one or more content overlays as well as an identification of the controller type (i.e., input means type).

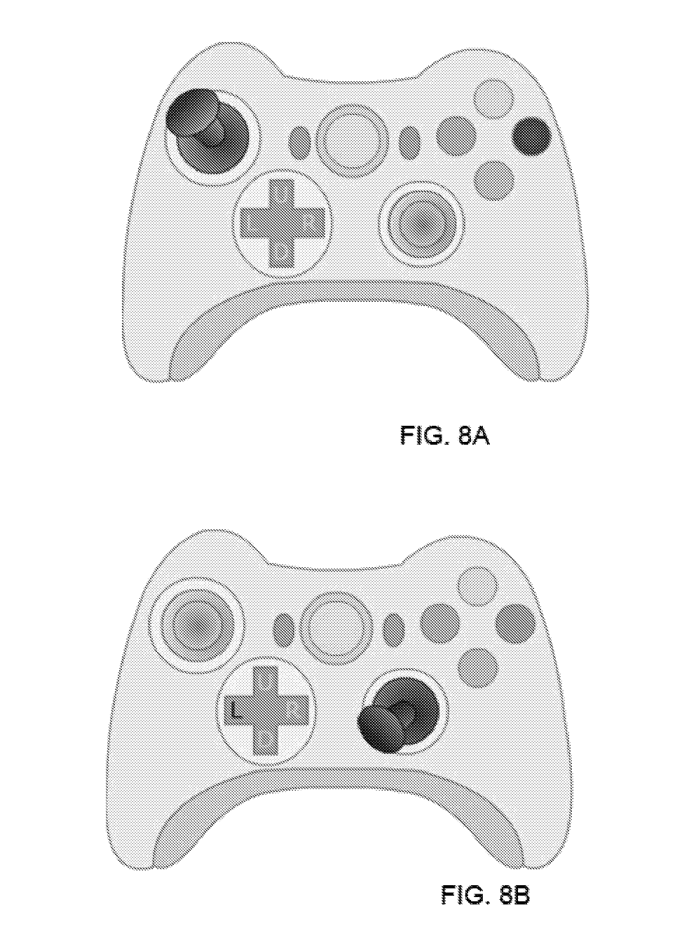

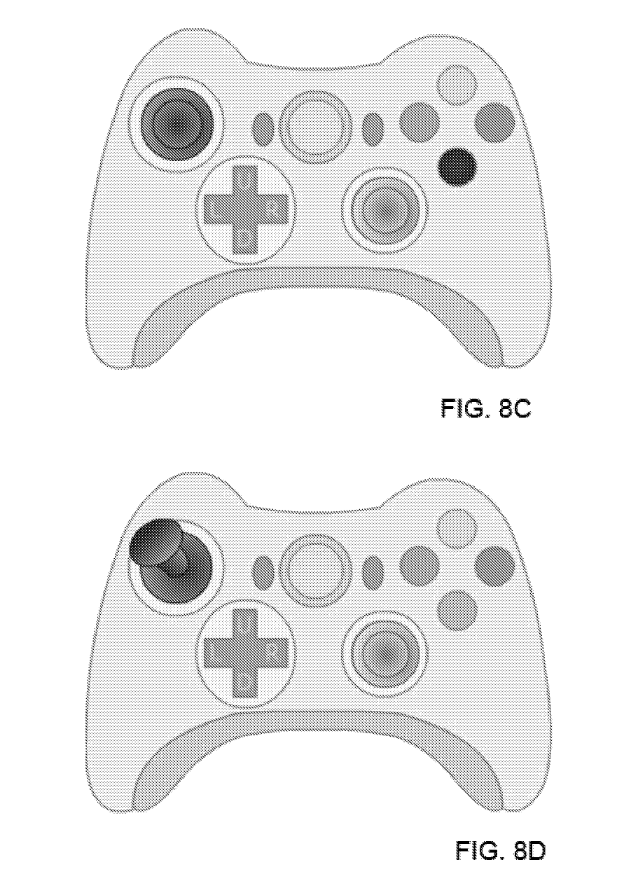

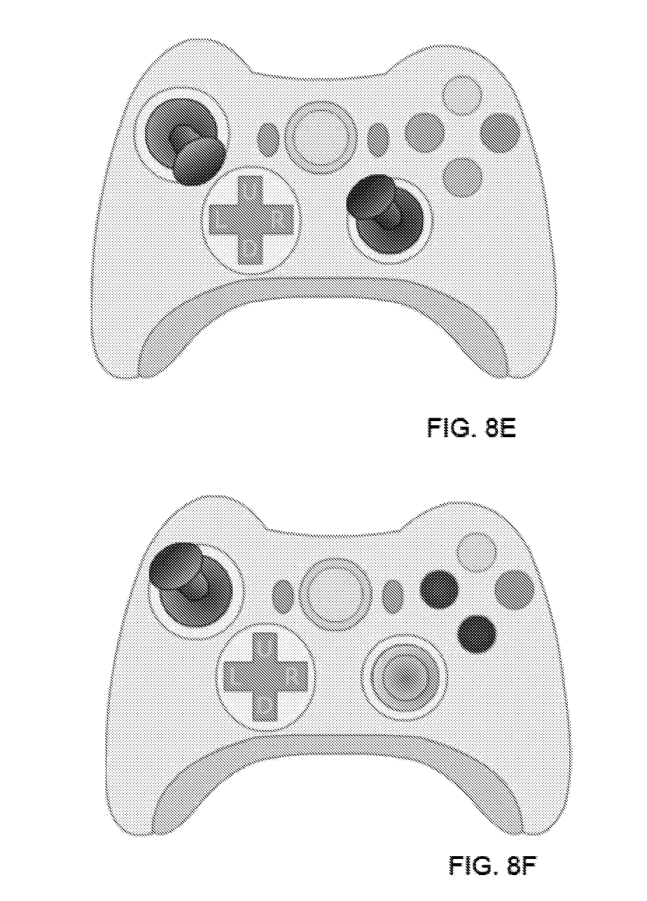

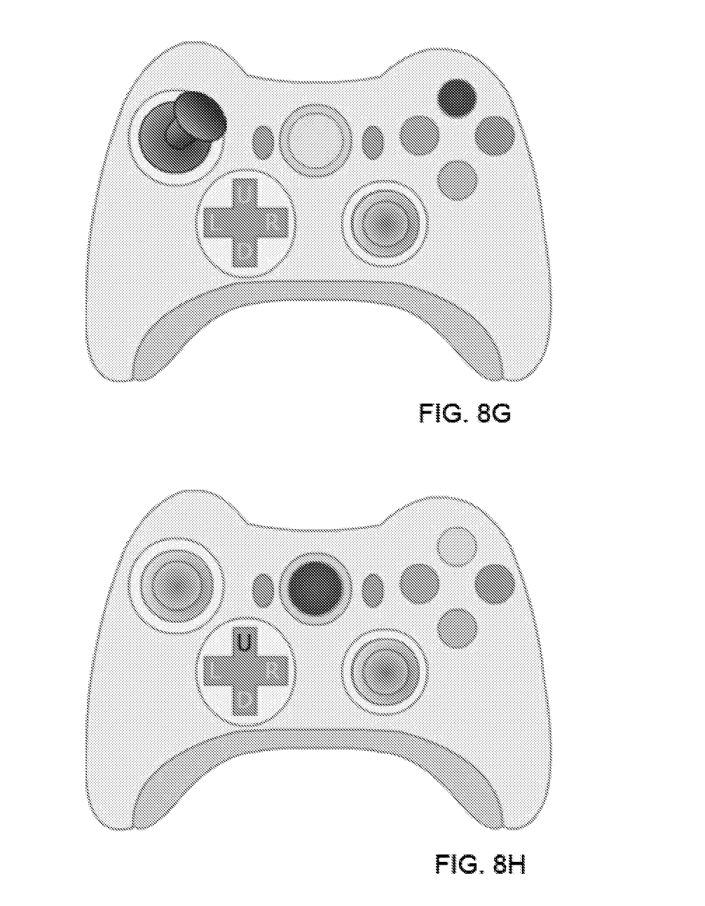

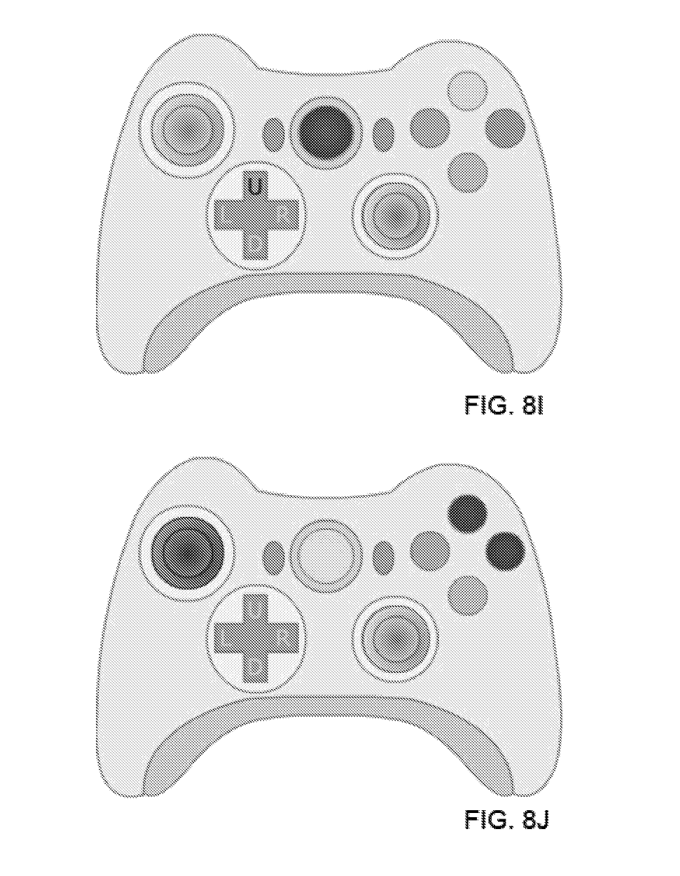

At step 654, the system generates a content overlay by using a graphical or other visual representation of the controller/input means, as identified by the controller identification information or data, and mapping each event of the event data to the action taken on the controller (See, FIGS. 8A-8J). The overlays allow those who view video content with the content overlay placed overtop a portion of the video content to see what actions were taken by a gamer or other user of the controller/input means, during the recording of the video content. This is particularly useful in situations such as video game events so that viewers can see what buttons are pressed or other actions are taken by the user playing a game that is being recorded or otherwise broadcast to such viewers.

At step 656, the system provides the content overlays, generally in conjunction with other video content, to the intended consumers of the video content/content overlays. Such provision of the content overlays can be done in real-time or near real-time, such as during live broadcasts, or provided at a later time via recorded content. The process of recording event data and processing content overlays may continue so long as desired. At some later point, the overlay content process will terminate, generally upon a termination request or other system interruption (step 658). At this point, the process terminates at step 660.

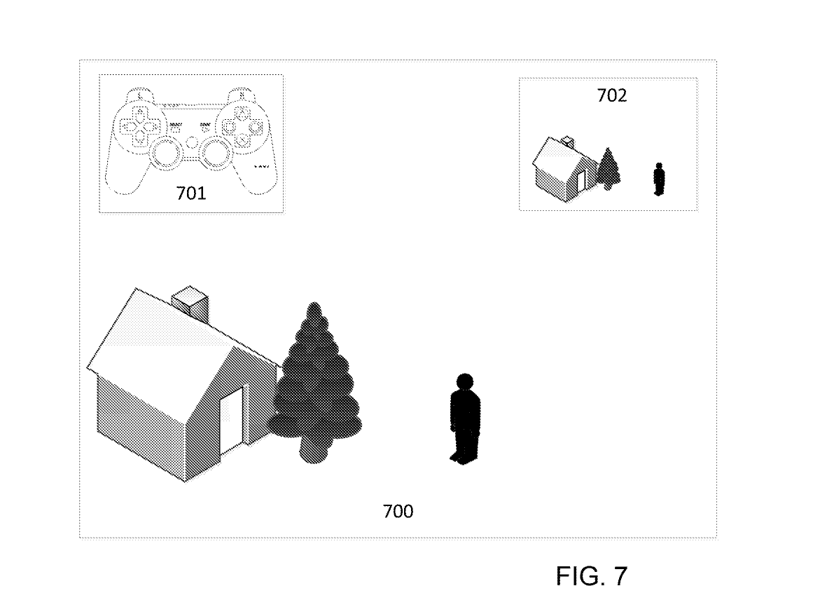

Turing now to FIG. 7, an illustration of an exemplary content overlay is shown. Game content 700 is shown overlaid with content overlays 701, 702 provided by the system. Controller content overlay 701 represents the controller utilized by the user playing the current game. In certain embodiments, the content overlay may display event data for the controller type used by the viewer, even where a different controller type was used to generate the content overlay.

Turning now to FIG. 8A-8J, illustrations of an exemplary embodiment of a controller that may be utilized in conjunction with the system in order to record controller events. These figures show a sampling of various positions controller elements could be put in to create controller events detectable and recordable by the system. Each of the figures shows a controller comprising a left analog stick, a directional pad, a plurality of system buttons located in the top center of the controller, a right analog stick and an arrangement of buttons in a diamond shape comprising a top button, right button, left button and a bottom button. FIG. 8A shows the left analog stick in an upper left position and the right button pressed. FIG. 8B shows the right analog stick in a lower left position and the left directional pad pressed. FIG. 8C shows the bottom button pressed. FIG. 8D shows the left analog stick in an upper left position. FIG. 8E shows the left analog stick in a lower right position and the right analog stick in an upper right position. FIG. 8F shows the left analog stick in an upper left position and both the left and lower buttons pressed. FIG. 8G shows the left analog stick in an upper right position and the top button pressed. FIG. 8H shows the up directional pad element pressed as well as a center system button pressed. FIG. 8I shows the up directional pad element pressed as well as a center system button pressed. FIG. 8J shows the top and right buttons pressed. While FIG. 8A-8J show a video game controller, one of ordinary skill in the art would appreciate that embodiments of the present invention could be used to provide content overlays for any type of controller, such as a keyboard, mouse, dance pad, joystick, pedal, steering wheel or any other controller type.

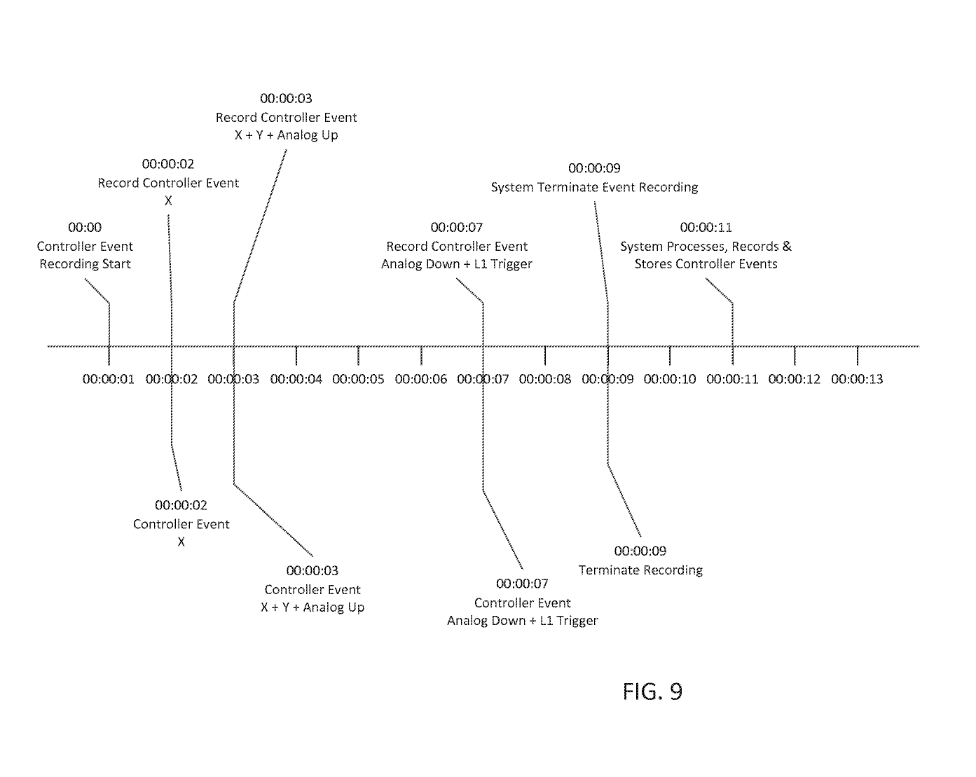

Turning now to FIG. 9, an illustration of a timeline showing controller events occurring and being recorded by the system is shown. Events occurring below the timeline show controller events input through use of a controller attached to the system. Events occurring above the timeline show the systems response to events occurring below the timeline. While events above and below the timeline may be shown occurring at the same time, one or ordinary skill in the art would appreciate that the timing may be off slightly as there may be a difference between a controller event occurring and that controller event being recorded by the system, whether due to inherent latencies of the system or other offsets. In certain embodiments of the present invention, these offsets may be determined by the system and the controller events recorded adjusted according to the determined amount of offset.

In FIG. 9, the timeline starts with the beginning of event data processing. At time 00:00:01, the system starts detecting and recording events. At time 00:00:02, the user presses an “X” button on a controller and the event is concurrently recorded by the system. At time 00:00:03, the user presses an “X” button, “Y” button and pushed up on an analog stick on the controller and the events are concurrently recorded by the system. At time 00:00:07, the user presses an analog stick down and pushes trigger “L1” on the controller and the events concurrently recorded by the system. At time 00:00:09, the user selects to terminate event recording and the system stops recording additional events from the controller. At time 00:00:11, the system processes all events recorded and associates each event with the time they occurred at, allowing for playback based on timed sequences of button presses. In embodiments where the content is being provided during a live broadcast, the events will be processed by the system and provided for immediate consumption as overlay content with the live broadcast video content or other content.

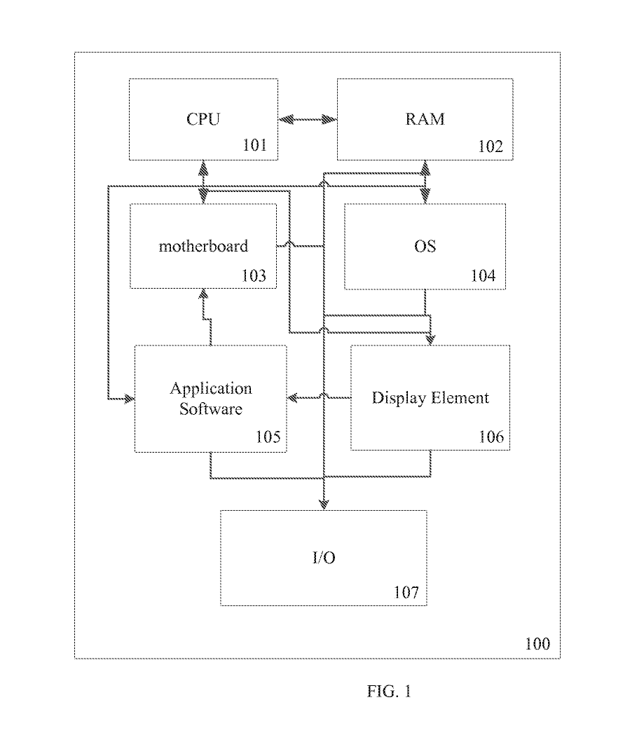

According to an embodiment of the present invention, the system and method is accomplished through the use of one or more computing devices. As shown in FIG. 1, One of ordinary skill in the art would appreciate that a computing device 100 appropriate for use with embodiments of the present application may generally be comprised of one or more of a Central processing Unit (CPU) 101, Random Access Memory (RAM) 102, a storage medium (e.g., hard disk drive, solid state drive, flash memory, cloud storage) 103, an operating system (OS) 104, one or more application software 105, one or more display elements 106 and one or more input/output devices/means 107. Examples of computing devices usable with embodiments of the present invention include, but are not limited to, personal computers, smart phones, laptops, mobile computing devices and tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network; however a user may be able to compose data offline that will be consumed by the system when the user is later connected to a network.

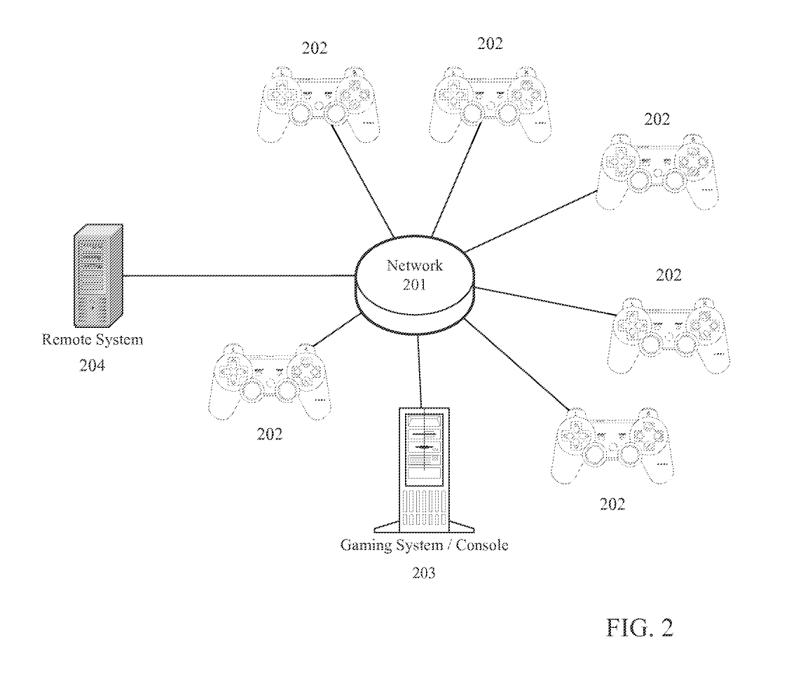

Referring to FIG. 2, a schematic overview of a system in accordance with an embodiment of the present invention is shown. The system is comprised of a gaming console, gaming system or other system for utilization with video gaming (collectively, gaming system 203) configured to electronically process and/or storing electronic information and data. Applications and/or modules in the gaming system 203 may retrieve and manipulate information in storage devices and exchange information through a Network 201 (e.g., the Internet, a LAN, Wi-Fi, Bluetooth, etc.). Applications and/or modules in gaming system 203 may also be used to manipulate information stored remotely and process and analyze data stored remotely across a Network 201 (e.g., the Internet, a LAN, Wi-Fi, Bluetooth, etc.).

According to an exemplary embodiment, as shown in FIG. 2, exchange of information through the Network 201 may occur through one or more high speed connections. In some cases, high speed connections may be over-the-air (OTA), passed through networked systems or directly connected to one or more Networks 201. In certain embodiments, Network 201 may involve the use or routers or other data communication and routing devices. Such routing devices are completely optional and other embodiments in accordance with the present invention may or may not utilize one or more routers. One of ordinary skill in the art would appreciate that there are numerous ways gaming system 203 may connect to Network 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to gaming system 203 via Network 201 or other network in numerous ways. For instance, a component may connect to the system i) through a controller device 202 or remote system 204 directly connected to the Network 201, ii) through a controller device 202 or remote system 204 connected to the Network 201 through a routing device, iii) through a controller device 202 or remote system 204 connected to a wireless access point or iv) through a controller device 202 or remote system 204 via a wireless connection (e.g., WIFI, Bluetooth, near field communication (NFC) means, CDMA, GMS, 3G, 4G) to the Network 201. One of ordinary skill in the art would appreciate that there are numerous ways that a component may connect to gaming system 203 via Network 201, and embodiments of the present invention are contemplated for use with any method for connecting to gaming system 203 via Network 201. Furthermore, gaming system 203 could acting as a host for controller devices 202 or remote systems 204 to connect directly to.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

According to an embodiment of the present invention, a data store may be comprised of one or more of a database, file storage system, relational data storage system or any other data system or structure configured to store data, preferably in a relational manner. In a preferred embodiment of the present invention, the data store may be a relational database, working in conjunction with a relational database management system (RDBMS) for receiving, processing and storing data. In the preferred embodiment, the data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system for providing a universal controller interpreter, the system comprising:
a universal controller interpretation module, comprising computer-executable code stored in non-volatile memory, and
a processor,
one or more input means, wherein at least one of said input means is a controller device,
wherein said universal controller interpretation module, said processor and said one or more input means are operably connected and are configured to:
receive event data and controller identification data;
process controller identification data in order to identify the input means;
process event data into one or more input events;
interpret each of said one or more input events into game events usable by a running game; and
implement said game events for said running game.

2. The system of claim 1, wherein said universal controller interpretation module, said processor and said one or more input means are further configured to retrieve controller identification information from a remote computing system.

3. The system of claim 2, wherein said universal controller interpretation module, said processor and said one or more input means are further configured to retrieve controller event information from said remote computing system, wherein said controller event information is associated with said controller identification information and enables said universal controller interpretation module to process event data from said input means.

4. The system of claim 1, wherein said universal controller interpretation module, said processor and said one or more input means are further configured to enter into a controller training process when said controller identification data is unknown to said universal controller interpretation module.

5. The system of claim 4, wherein said universal controller interpretation module, said processor and said one or more input means are further configured to receive event data training information from said input means.

6. The system of claim 5, wherein said universal controller interpretation module, said processor and said one or more input means are further configured to process event data training information into useable event data.

7. The system of claim 6, wherein said universal controller interpretation module, said processor and said one or more input means are further configured to generate controller identification information for an unknown controller type from said useable event data.

8. The system of claim 7, wherein said universal controller interpretation module, said processor and said one or more input means are further configured to store said controller identification information for later use with said input means.

9. A method for providing a universal controller interpreter, the method comprising the steps of:
receiving at a universal controller interpretation module, event data and controller identification data from an input means;
processing controller identification data in order to identify the input means;
processing event data into one or more input events;
interpreting each of said one or more input events into game events usable by a running game; and
implementing said game events for said running game.

10. The method of claim 9, further comprising the step of retrieving controller identification information from a remote computing system.

11. The method of claim 10, further comprising the step of retrieving controller event information from said remote computing system, wherein said controller event information is associated with said controller identification information and enables said universal controller interpretation module to process event data from said input means.

12. The method of claim 1, further comprising the step of entering into a controller training process when said controller identification data is unknown to said universal controller interpretation module.

13. The method of claim 12, further comprising the step of receiving event data training information from said input means.

14. The method of claim 13, further comprising the step of processing event data training information into useable event data.

15. The method of claim 14, further comprising the step of generating controller identification information for an unknown controller type from said useable event data.

16. The method of claim 15, further comprising the step of storing said controller identification information for later use with said input means.
